(19) United States
(12) Patent Application Publication
(10) Pub. No.: US 2019/0190166 A1
(43) Pub. Date: Jun. 20, 2019

(54) INTEGRATED BASE STATION ANTENNA

(71) Applicant: Rosenberger Technology (Kunshan) Co., Ltd, Kunshan (CN)

(72) Inventors: Jinju Wang, Kunshan (CN); Lishao Cai, Kunshan (CN); Kun Wang, Kunshan (CN); Ping Huang, Kunshan (CN)

(21) Appl. No.: 15/891,526

(22) Filed: Feb. 8, 2018

(30) Foreign Application Priority Data
Dec. 18, 2017 (CN) 201711362926.5

(51) Int. Cl. H01Q 21/28; H01Q 1/38

(52) U.S. Cl. CPC H01Q 21/28; H04B 7/0413; H01Q 1/38

(57) ABSTRACT

The present invention discloses an integrated base station antenna. The integrated base station antenna comprises a macro-station antenna and a massive multiple-input multiple-output antenna which are integrally mounted in an antenna housing. The integrated base station antenna can perform hybrid network layout, thereby the network capacity can be effectively expanded and the network efficiency can be improved.

### RELATED APPLICATIONS

The present application claims priority under 35 U.S.C. § 119 to People's Republic of China patent application Ser. No. 201711362926.5, which was filed on Dec. 18, 2017, the entire contents of which are incorporated herein by reference.

### FIELD OF THE INVENTION

The present invention relates to the field of mobile communication applied to a base station antenna system, and in particular to a novel base station antenna in which a traditional macro-station antenna and a massive multiple-input multiple-output antenna are integrated.

### BACKGROUND

At present, with the rapid development in the field of wireless communications, an information communication technology (ICT) such as the mobile Internet and the Internet of Things will generate explosive growth in data traffic, and a wireless network needs to be capable of supporting very large data traffic. A massive multiple-input multiple-output (MIMO) technology has become the current research hotspot due to its advantages of a wireless network, which can provide larger network capacity, better reliability and higher energy efficiency. With the massive MIMO technology, more antennas brought more freedom to the propagation channel and become one of the key technologies of the fifth generation mobile communication (5G) in terms of higher performance in data transmission rate and link reliability.

As shown in FIG. 1, in the existing distributed antenna feed antenna, a macro-station antenna, the massive MIMO antenna and other antennas are independent modules and are networked together to improve the network capacity. However, such a distributed antenna system is low in integration level, long in network deployment time and high in network deployment cost, with the pressures that the network deployment space is not enough, and the like.

### SUMMARY OF THE INVENTION

An objective of the present invention is to overcome the defects of the prior art, and provide an integrated base station antenna which is high in integration level and capable of effectively expanding the network capacity.

To fulfill said objective, the present invention provides the following technical solution: an integrated base station antenna comprises a macro-station antenna and a massive multiple-input multiple-output antenna, wherein the macro-station antenna and the massive multiple-input multiple-output antenna are integrally mounted in the same antenna housing.

According to the integrated base station antenna disclosed by the present invention, the traditional macro-station antenna and the massive multiple-input multiple-output antenna are integrated in the same antenna, such that the macro-station antenna and the massive multiple-input multiple-output antennas or other active or passive antennas as a supplementary module are subject to hybrid network layout, thereby effectively solving the problem that the traditional distributed antenna network layout space is not enough while effectively reducing the network layout time and cost. In addition, the network capacity can be effectively expanded and the network efficiency can be improved compared to the traditional macro-station, and therefore the user experiment is promoted, and the product's competitiveness is improved.

### BRIEF DESCRIPTION OF THE DRAWINGS

FIG. 1 is a functional block diagram of a traditional distributed antenna feed system;

FIG. 2 is a functional block diagram of the present invention;

FIG. 3 is a schematic structural drawing of an embodiment of the present invention;

FIG. 4 is a schematic structural drawing of another embodiment of the present invention;

FIG. 5 is a schematic drawing of arraying of sub-arrays of the massive multiple-input multiple-output antenna of the present invention;

FIG. 6 is another schematic drawing of arraying of the massive multiple-input multiple-output antenna of the present invention; and

FIG. 7 is a schematic structural drawing of the single-frequency or multi-frequency massive multiple-input multiple-output antenna of the present invention.

Reference signals represent the following components:

1—macro-station antenna; 2—massive multiple-input multiple-output antenna; 3—antenna back plate.

### DETAILED DESCRIPTIONS OF THE PREFERRED EMBODIMENTS

The technical solution of the embodiments of the present invention will be clearly and completely described below with reference to the accompanying drawings of the present invention.

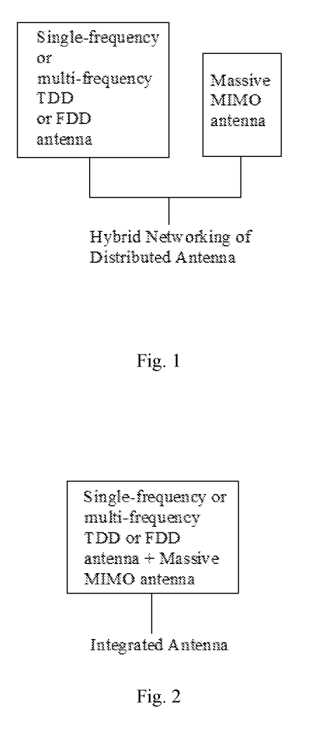

As shown in FIG. 2, the present invention discloses an integrated base station antenna, which comprises a macro-station antenna 1 and a massive multiple-input multiple-output antenna 2 which are integrated in one antenna.

Specifically, the macro-station antenna 1 and the massive multiple-input multiple-output antenna 2 are integrally mounted in the same antenna housing (not shown in drawings) and operate independently inside the antenna housing. Compared with the existing distributed base station framework, the integrated base station antenna disclosed by the present invention lies in that the macro-station antenna 1 and the massive multiple-input multiple-output antenna 2 are networked together by being arranged in the same antenna housing to improve the integration level, thereby effectively solving the problem that the traditional distributed antenna network layout space is not enough while effectively reducing the network layout time and cost. In addition, the network capacity can be effectively expanded and the network efficiency can be improved compared to the traditional macro-station, and therefore the user experiment is promoted.

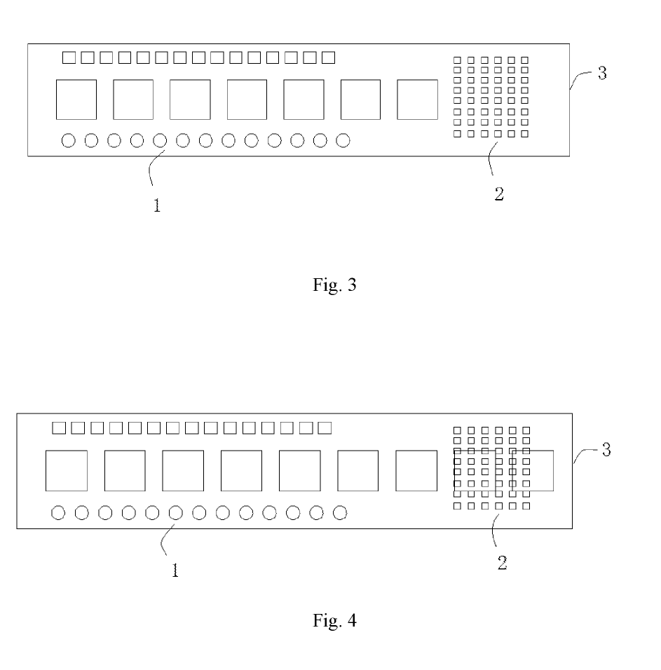

In a specific implementation, the macro-station antenna 1 and the massive multiple-input multiple-output antenna 2 can be integrally mounted on the same reflective back plate 3, and then integrally mounted in the same antenna housing through the reflective back plate 3. As shown in FIG. 3, on the reflective back plate 3, the macro-station antenna 1 and the massive multiple-input multiple-output antenna 2 can be distributed independently, i.e., they are not crossed.

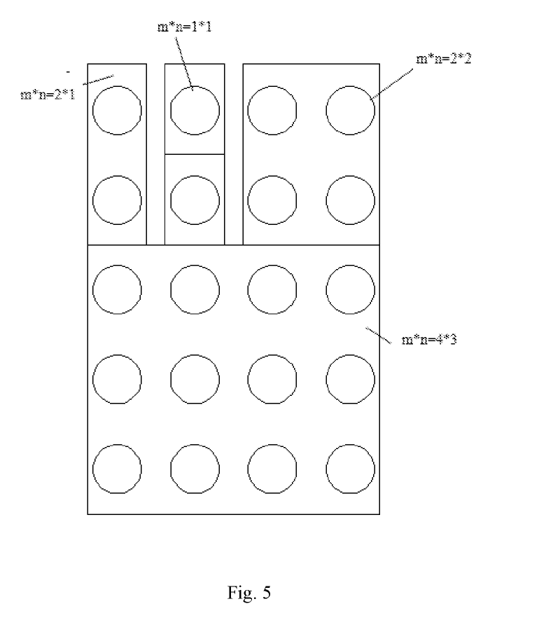

As an alternative scheme, the macro-station antenna 1 and the massive multiple-input multiple-output antenna 2 can be partially/fully distributed in an interleaving manner. As shown in FIG. 4, on the reflective back plate 3, there is a height difference between the macro-station antenna 1 and the massive multiple-input multiple-output antenna 2. If the height of the macro-station antenna 1 is larger than a set height of the massive multiple-input multiple-output antenna 2, the massive multiple-input multiple-output antenna 2 can be embedded into the macro-station antenna 1 and is distributed on the reflective back plate 3 in an interleaving manner, or the macro-station antenna 1 and the massive multiple-input multiple-output antenna 2 are partially distributed in a crossing manner (as shown in FIG. 4), or may be fully distributed on the reflective back plate 3 in an interleaving manner. Therefore, the space of the reflective back plate 3 can be effectively saved, the problem that the traditional distributed antenna layout space is not enough is further solved, and the integration level of the base antenna is improved.

As another alternative scheme, the macro-station antenna 1 and the massive multiple-input multiple-output antenna 2 can also be mounted on the respective reflective back plates 3, and then integrally mounted in the same antenna housing through the respective reflective back plates 3 to realize the integration. Under such a scheme, the macro-station antenna 1 and the massive multiple-input multiple-output antenna 2 are distributed independently in the antenna housing.

The macro-station antenna 1 here can adopt any one of the traditional macro station antennas, such as a single-frequency or multi-frequency multi-port TDD antenna, a single-frequency or a multi-frequency multi-port FDD antenna, and the like.

Specifically, as shown in FIG. 3 and FIG. 4, the macro-station antenna 1 comprises n columns of 2G/3G/4G antenna arrays, where n is a natural number greater than or equal to 1. The frequency bands between the antenna arrays may be the same or different, that is, they may be single-frequency macro-station antennas or multi-frequency macro-station antennas.

The massive multiple-input multiple-output antenna 2 specifically includes a×b groups of sub-arrays, and each group of sub-arrays is composed of m×n antenna oscillator units and a plurality of radio-frequency ports, where a and b are the number of rows and columns of the sub-array modules in the single-cluster massive multiple-input multiple-output antenna; m and n are the number of rows and columns of the oscillator units in each sub-array, and a, b, m and n are all natural numbers greater than or equal to 1.

There are many array cases for the sub-arrays. As shown in FIG. 5, the sub-arrays that form a single-cluster massive multiple-input multiple-output antenna include a1×b1 groups of m×n=2×1 sub-arrays, or a2×b2 groups of m×n=1×1 sub-arrays, or a3×b3 groups of m×n=2×2 sub-arrays, or a4×b4 groups of m×n=4×3 sub-arrays, etc.

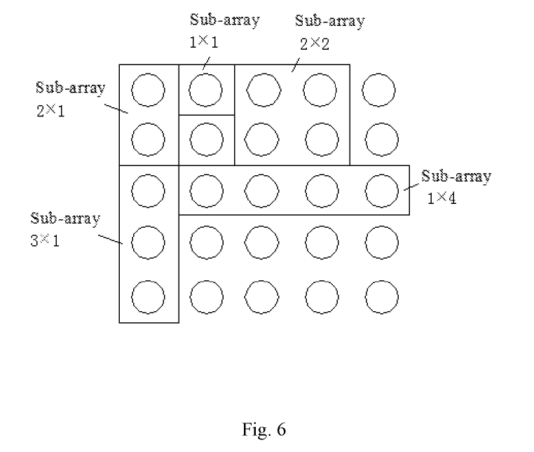

As shown in FIG. 6, the sub-arrays that form the massive multiple-input multiple-output antenna include a1×b1 groups of m×n=2×1 sub-arrays, or a2×b2 groups of m×n=1×1 sub-arrays, or a3×b3 groups of m×n=2×2 sub-arrays, or a4×b4 groups of m×n=3×1 sub-arrays, or a5×b5 groups of m×n=1×4 sub-arrays, etc. There are many array cases for the sub-arrays, which will not be enumerated one by one herein.

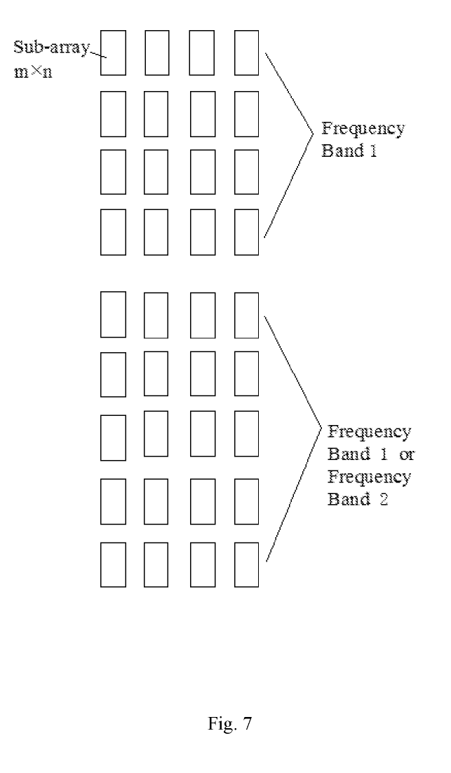

Therefore, the massive multiple-input multiple-output antenna of the present invention may be a massive multiple-input multiple-output antenna including single-cluster single-frequency sub-arrays, wherein the single cluster is an a×b group of sub-arrays, as described above; or may also be a massive multiple-input multiple-output antenna including multiple clusters of single-frequency sub-arrays (that is, sub-arrays in each cluster operate in the same frequency band) or multiple clusters of multiple-frequency sub-arrays (that is, the frequency of each sub-array in each cluster may be different), wherein multiple clusters may be is N a×b groups of sub-arrays (N≥1). As shown in FIG. 7, a plurality of sub-arrays in the upper band operates in frequency band 1 to form a massive multiple-input multiple-output antenna including single-cluster single-frequency sub-arrays. As shown in FIG. 7 also, a plurality of sub-arrays in the lower band operates in frequency band 1, and some operate in frequency band 2, thus forming a massive multiple-input multiple-output antenna including multi-cluster multi-frequency sub-arrays.

The antenna oscillator unit herein may be a single-polarized antenna oscillator unit or a dual-polarized antenna oscillator unit or a tri-polarized antenna oscillator unit. The radio frequency ports in each group of sub-arrays correspond to the polarization numbers of the corresponding antenna oscillator units. If each group of sub-arrays includes m×n single-polarized antenna oscillator units, the sub-array is correspondingly provided with one radio-frequency port; if each group of sub-arrays includes m×n dual-polarized antenna oscillator units, the sub-array is correspondingly provided with two radio-frequency ports, and so on.

The antenna oscillator units in each sub-array operate together. However, any one or more sub-arrays can operate among multiple groups of sub-arrays, and the other sub-arrays can operate randomly or not operate. For example, the massive multi-input multiple-output antenna includes four groups of sub-arrays, wherein each groups of sub-arrays consists of two antenna oscillator units, one of the four groups of sub-arrays may operate and the other three groups of sub-arrays do not operate, and the two antenna oscillator units in this group of sub-arrays operate together.

Preferably, a decoupling structure (not shown) is disposed between the sub-arrays in different frequency bands, that is, the decoupling technology reduces the mutual coupling between the arrays of the different frequency bands, ensures excellent network performance, and solves the problem of antenna deployment. During implementation, the decoupling structure can be added to the antenna oscillator unit to decouple in a line manner, or a decoupling module can also be mounted on the reflective back plate to achieve decoupling.

In addition, the massive multiple-input multiple-output antenna of the present invention may be a passive antenna or an active antenna, the active antenna being an active module that is added to each group of sub-arrays, such that the passive antenna is changed into the active antenna.

The technical content and technical features of the present invention have been disclosed as above. However, those skilled in the art may still make substitutions and modifications without departing from the spirit of the present invention based on the teaching and disclosure of the present invention. Therefore, the protection scope of the present invention should not be limited to the disclosure of the embodiments, but should include various substitutions and modifications without departing from the present invention, and is covered by the claims of the patent application.

1. An integrated base station antenna, comprising a macro-station antenna and a massive multiple-input multiple-output antenna, wherein the macro-station antenna and the massive multiple-input multiple-output antenna are integrally mounted in the same antenna housing.

2. The integrated base station antenna according to claim 1, wherein the macro-station antenna and the massive multiple-input multiple-output antenna are independently distributed in the antenna housing respectively, or partially/fully distributed in an interleaving manner.

3. The integrated base station antenna according to claim 2, further comprising reflective back plates, wherein the macro-station antenna and the massive multiple-input multiple-output antenna are integrally mounted on the same reflective back plate, or respectively mounted on the respective reflective back plates, and are mounted in the antenna housing through the reflective back plates.

4. The integrated base station antenna according to claim 1, wherein the macro-station antenna comprises n columns of 2G/3G/4G antenna arrays, and n is a natural number greater than or equal to 1.

5. The integrated base station antenna according to claim 4, wherein the macro-station antenna includes at least one of a single-frequency TDD antenna, a multi-frequency TDD antenna, a single-frequency FDD antenna, and a multi-frequency FDD antenna.

6. The integrated base station antenna according to claim 1, wherein the massive multiple-input multiple-output antenna is a passive antenna or an active antenna.

7. The integrated base station antenna according to claim 6, wherein the massive multiple-input multiple-output antenna comprises a×b groups of sub-arrays, and each group of sub-arrays comprises m×n antenna oscillator units, wherein a and b are the numbers of rows and columns of sub-array modules in the single-cluster massive multiple-input multiple-output antenna respectively; m and n are the number of rows and columns of the oscillator units in each sub-array, and a, b, m and n are natural numbers greater than or equal to 1 respectively.

8. The integrated base station antenna according to claim 7, wherein the multiple groups of sub-arrays operate in the same frequency band or different frequency bands.

9. The integrated base station antenna according to claim 7, wherein the antenna oscillator units in each group of sub-arrays operate together, any one or more sub-arrays in the multiple groups of sub-arrays operate, and other sub-arrays can operate randomly or not operate.

10. The integrated base station antenna according to claim 8, wherein a decoupling structure is arranged between the sub-arrays in different frequency bands.
